(19) United States
(12) Patent Application Publication
(10) Pub. No.: US 2011/0067954 A1
(43) Pub. Date: Mar. 24, 2011

(54) Ladder Safety Device

(76) Inventor: Clifton Deal, Mineral Bluff, GA (US)

(21) Appl. No.: 12/722,835

(22) Filed: Mar. 12, 2010

Related U.S. Application Data
(63) Continuation-in-part of application No. 11/583,996, filed on Oct. 19, 2006, now abandoned.
(60) Provisional application No. 60/728,501, filed on Oct. 20, 2005.

(51) Int. Cl. E06C 7/18; E06C 7/44; E06C 7/46

(52) U.S. Cl. 182/107; 182/172

(57) ABSTRACT

A ladder safety that prevents sideways tipping accidents having a pair of struts extending outwardly and downward from the lower rails of the ladder with the struts making contact with a base surface or the ground. The struts can be clamped or pinned to the ladder, or they can be attached to a horizontal bar or other member that passes through one of the hollow rungs of the ladder. These struts can be telescoping with pins or other devices to allow adjustment. The struts can be fixed or removable, and can rotate and pivot to any angle. Each of the struts can further include a shoe that contacts the base surface or ground to provide extra stability. The shoe can be angled so that it is flat on the ground at the desired angle. A second pair of similar struts near the top of the ladder can act as roof braces, while at least one extender leg can extend one ladder leg to be longer than the other.

This is a continuation-in-part of copending application Ser. No. 11/583,996 filed Oct. 19, 2006. That application claimed priority from U.S. Provisional patent application No. 60/728,501 filed Oct. 20, 2005. Application Ser. Nos. 11/583,996 and 60/728,501 are hereby incorporated by reference.

### BACKGROUND

1. Field of the Invention

The present invention relates generally to safety devices and more particularly to a ladder safety device that can make any ladder safe from sliding sideways.

2. Description of the Problem Solved

Ladders, especially extension ladders, are very dangerous devices. Numerous falls occur each year that are the result of a ladder sliding sideways. Normally a ladder is placed up against a structure or up over the eve of a building roof. Ladder feet generally keep the base of the ladder from moving in or out; however, there is normally absolutely nothing to keep the top of the ladder from slipping sideways except the small amount of friction where the upper part of the ladder meets the structure.

A recently documented accident is typical of the danger of extension ladders. A contractor was descending an extension ladder that gave him access to a garage roof. The height of the roof eve was 12 feet above a concrete driveway. The contractor tried to descend with a paint can hanging from his left hand and a shingle hanging from his right hand. As he descended, the end of the shingle got between his right foot and the ladder rung. His foot slipped completely off the rung. As he started to fall, he dropped the paint can and grabbed the right ladder rail. If the ladder had not slipped, he could have slid down the right ladder rail; however, since his center of gravity was to the right of the ladder, a lever arm was created, and the ladder began to slip to the right. As soon as the ladder slipped beyond the eve of the roof, it fell causing the contractor to fall directly on his back on the concrete from a height of around 4-5 feet. Serious injuries resulted.

What is very badly needed is a simple device that works on all types of even and uneven ladder surfaces that will positively prevent a ladder from slipping sideways no matter what type of lever arm or off-center force may be present.

### SUMMARY OF THE INVENTION

The present invention relates to a ladder safety that prevents sideways tipping accidents, the device having a pair of struts extending outwardly and downward from the lower rails of the ladder with the struts making contact with a base surface or the ground. The struts can be clamped or pinned to the ladder, or they can be attached to a horizontal bar or other member that passes through one of the hollow rungs of the ladder. These struts can be telescoping with pins or other devices to allow adjustment. The struts can be fixed or removable. Each of the struts can further include a shoe that contacts the base surface or ground to provide extra stability. The shoe can be angled so that it is flat on the ground at the desired strut angle. A preferred strut angle is between 35 and 50 degrees. A different embodiment of the invention can have a horizontal extension from the side of the ladder with a vertical support on each side.

### DESCRIPTION OF THE FIGURES

Attention is now directed to several drawings to aid in understanding features of the present invention.

FIG. 1 shows a strut-type embodiment of the present invention.

FIG. 2 shows a leg-type embodiment of the present invention.

FIG. 3 shows an embodiment of the present invention with optional roof mount, swiveling side mounts and a leg extender.

FIG. 4 shows a combination roof mount and leg mount embodiment.

FIG. 5 shows the use of a leg extender.

FIG. 6 shows a rung insert that can be used to attach struts to a ladder.

Several drawings and illustrations have been presented to better disclose the present invention. The scope of the present invention is not limited to what is shown in the Figures.

### DESCRIPTION OF THE INVENTION

The present invention relates to a safety attachment that works with any ladder that positively prevents the ladder from slipping sideways. The invention works by widening the effective base of the ladder with struts or legs, and thereby moving the fulcrum of any lever arm that might develop from an off-centerline load.

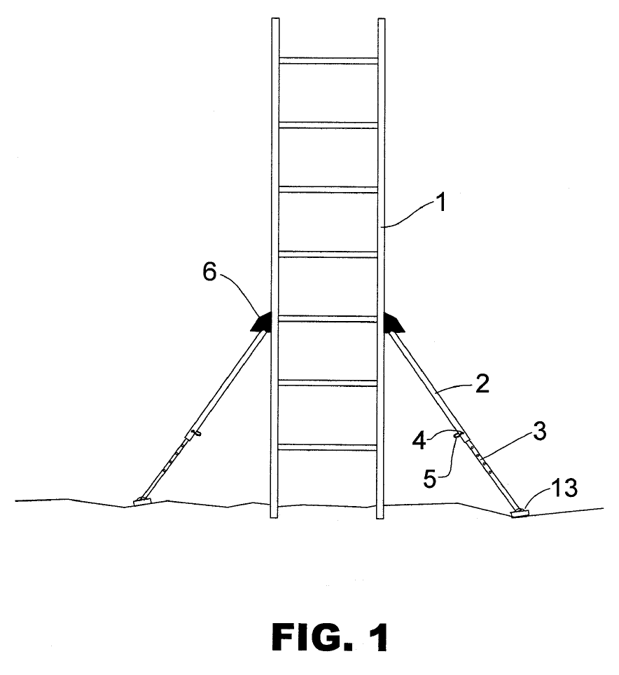

Turning to FIG. 1, an embodiment of the present invention is seen that operates on the principle of struts. Here a ladder 1 is prevented from tipping or slipping sideways a telescoping strut 2. The bottom part 3 can telescope out of the top 2. A pin 5 can be placed through a set of aligned pin holes 4 to lock the lower part to match the height of the base soil, driveway, etc. where the strut is positioned. A foot 13 can be rubber, metal or any other material and can optionally contain anti-slip grooves. A stop bar 6 or any other type of connection attaches the strut 2 to the ladder 1. Normally a rod or bar runs through a hollow rung on the ladder side-to-side to attach the struts on each side; however, any manner of attaching the strut 2 to the ladder 1 is within the scope of the present invention. The struts can be removable or fixed and can telescope. The embodiment of FIG. 1 is very useful because the two struts do not have to be set to the same length. This allows the apparatus to be used on uneven or non-level surfaces.

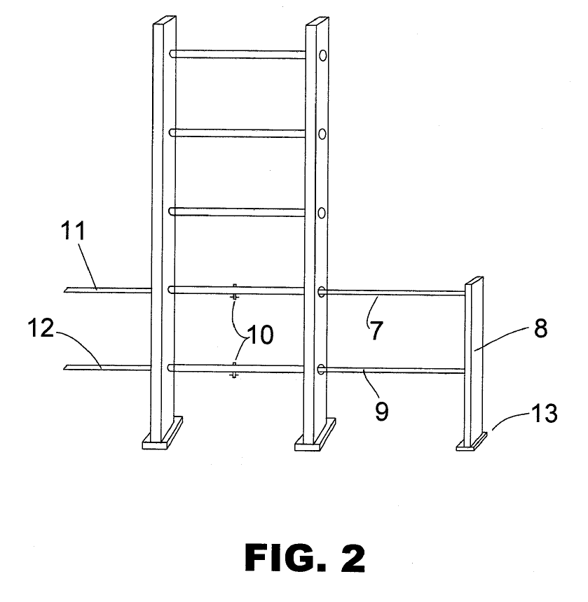

FIG. 2 shows an alternate embodiment of the present invention. Here a top bar 7 and bottom bar 9 run through the ladder rungs and telescope into a mating bars 11 and 12 from the other side. A vertical portion 8 with a foot 13, similar to the foot in FIG. 1, extends to the base surface. This embodiment is most useful for flat base surfaces such as driveways, etc. Lock pins 10 can lock the extended verticals 8 to a fixed distance from the ladder 1.

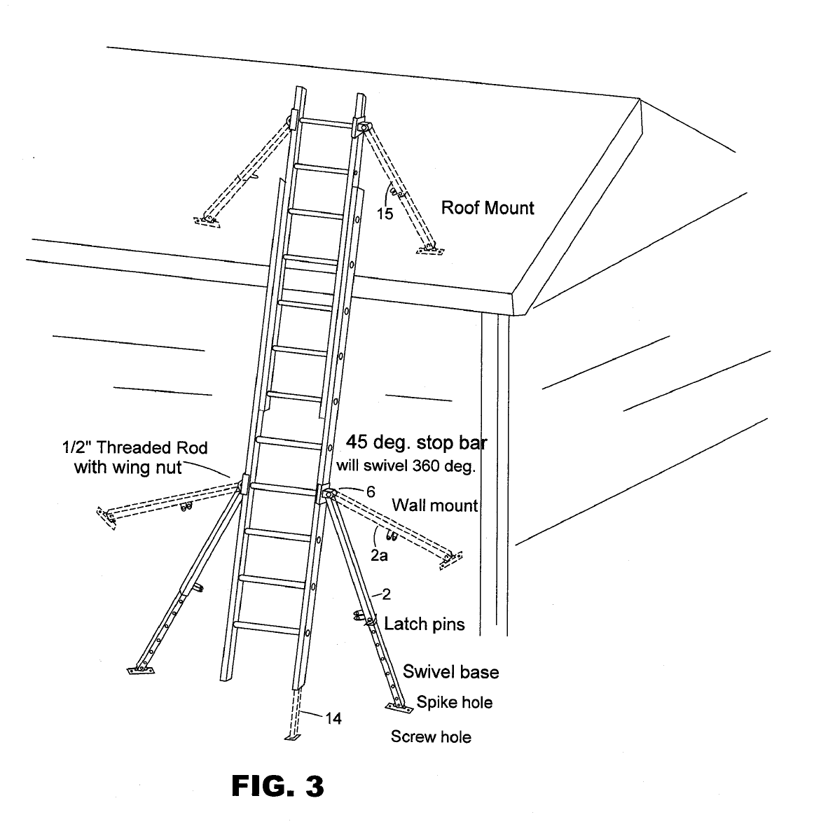

FIG. 3 shows an embodiment of the present invention with several other features. It can be seen that the strut 2 can be shortened and swiveled to any angle to make to a wall mount 2a. By any angle, I mean that the strut can rotate on the base 6 360 degrees, and it can pivot about the base 6 on a pinned attachment. The strut 2a forming a wall mount has generally been pivoted up to match the wall and then rotated into a position where contact can be made by extending the strut 2a laterally. The base or shoe of the strut can than be positively attached to either the ground, the building, or to any other fixed surface. FIG. 3 also shows an optional roof mount 15 which can be the same strut 2 moved upward or an additional second strut set. Again, the strut 15 can rotate and pivot to any angle as well as extend and be affixed to any firm surface. Finally, FIG. 3 shows an optional leg extension 14 that can be used to anchor to a position different from the other leg. This is useful when the ladder is not on level ground.

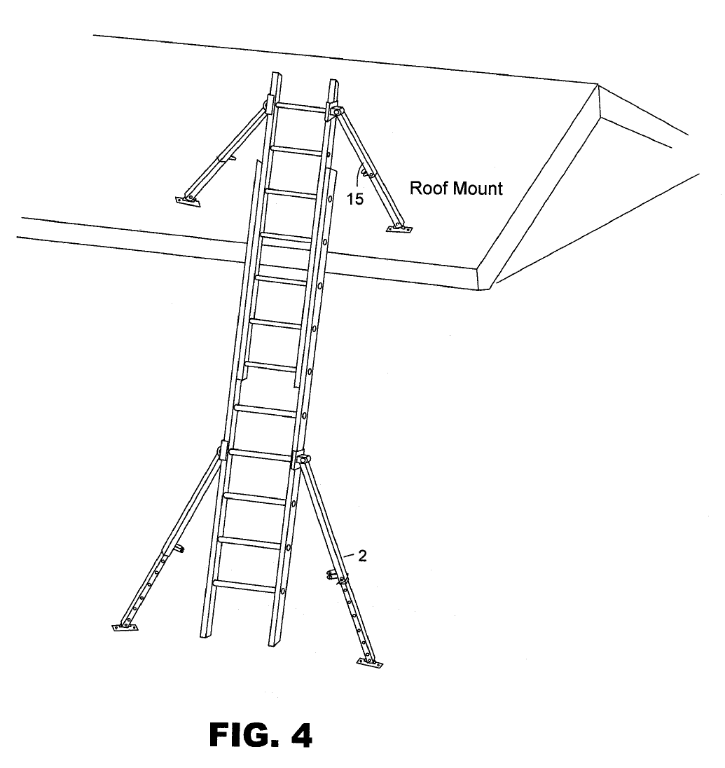

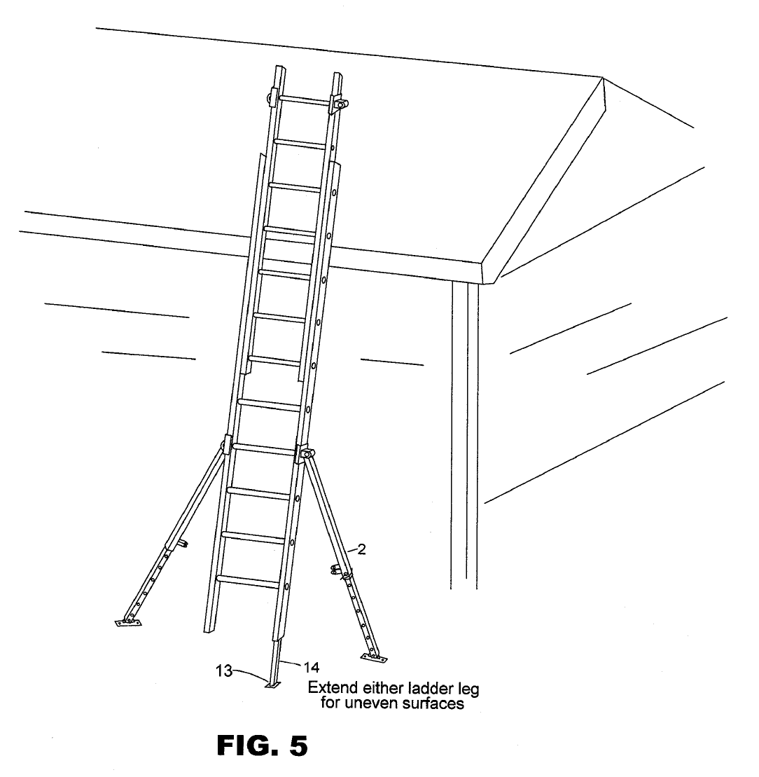

FIG. 4 shows a version of the embodiment of FIG. 3 on fairly level ground with a roof mount 15 in place. FIG. 5 shows a version of the embodiment of FIG. 3 with the leg extender 14 shown placed on a lower platform than the other leg. This is very useful during the construction of buildings where there may be level surfaces at different heights that it would be desirable to place the ladder on.

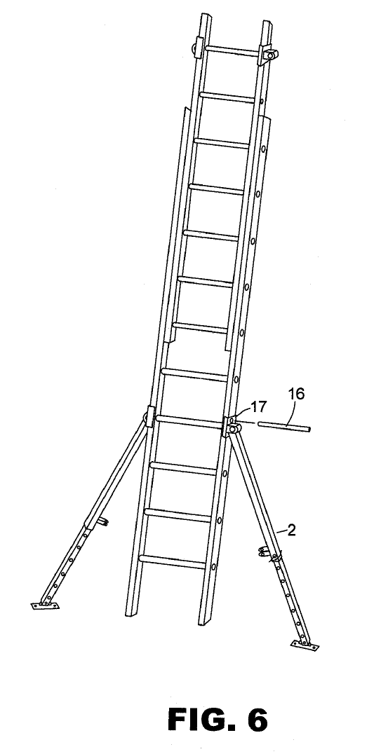

FIG. 6 shows a tubular insert 16 that can pass through a hole 17 in the base of the strut 2 to attach the strut base to the ladder rail. This tubular insert 16 can then be clipped, pinned or bolted into final position on the ladder rail.

The embodiments of the invention shown in FIGS. 1-6 are very useful for increasing the safety of working on a ladder, especially a long extension ladder (a longer ladder creates more of a lever arm for any off-centerline load). While several descriptions and illustrations have been provided to better aid in understanding the present invention, a person of skill in the art will realize that many changes and variations are possible without departing from the spirit of the invention. Each of these changes and variations is within the scope of the present invention.

I claim:

1. A ladder safety device comprising a pair of struts extending outwardly and downward from the lower rails of a ladder, said struts capable of making contact with a fixed surface, said struts rotatable about an axis perpendicular to said rails being pivotable from a first position parallel to said rails through 180 degrees to a second position parallel to said rails, said struts also being extendable telescopically.

2. The ladder safety device of claim 1 further comprising a leg extender telescoping downward parallel to at least one of said rails.

3. The ladder safety device of claim 1 wherein said struts are removable.

4. The ladder safety device of claim 1 wherein each of said struts further includes a shoe.

5. The ladder safety device of claim 1 further comprising a horizontal member passing through a rung of said ladder, said horizontal member being mechanically coupled to each of said struts.

6. The ladder safety device of claim 1 further comprising a second set of struts also rotatable, pivotable and extendable near an upper end of said rails, said second set of struts acting as roof mounts.

7. A ladder safety device comprising:
a first pair of struts extending outwardly and downward from the lower rails of a ladder, said struts making contact with a fixed surface, said struts rotatable about an axis perpendicular to said rails being pivotable from a first position parallel to said rails through 180 degrees to a second position parallel to said rails, said struts also being extendable telescopically;
a leg extender telescoping downward parallel to at least one of said rails, wherein said leg extender extends said leg's length.

8. The ladder safety device of claim 7 further comprising a second pair of struts like said first pair of struts, said second pair of struts located near an upper end of said ladder, said second pair of struts capable of being affixed to a roof.

8. A method of preventing ladder tip-over accidents comprising:
providing left and right struts attachable to left and right rails of a safety ladder respectively, said struts forming angles with said rails, said struts each capable of being firmly attached to a fixed surface, wherein said struts are rotatable about an axis perpendicular to said rails and pivotable from a first position parallel to said rails through 180 degrees to a second position parallel to said rails, said struts also being extendable telescopically to contact said fixed surface.

9. The method of claim 8 further comprising providing a second pair of struts like said left and right struts near said ladder's upper end, wherein said second pair of struts can be firmly attached to a roof.

10. The method of claim 8 further comprising at least one leg extender capable of telescoping downward from one of said rails, wherein said leg extender extends said rail's length.

11. The method of claim 8 wherein said left and right struts are coupled to a horizontal member that passes through a rung of said ladder.

12. The method of claim 8 wherein said left and right struts each have flat shoe members on their distal ends.
